(19) United States
(12) Patent Application Publication
(10) Pub. No.: US 2015/0239353 A1
(43) Pub. Date: Aug. 27, 2015

(54) METHOD FOR CONTROLLING THE CHARGING OF A BATTERY OF AN ELECTRIC VEHICLE IN A NON-CONTACT CHARGING SYSTEM

(71) Applicant: RENAULT s.a.s., Boulogne-Billancourt (FR)

(72) Inventor: Samuel Cregut, Saint Remy Les Chevreuse (FR)

(73) Assignee: RENAULT s.a.s., Boulogne-Billancourt (FR)

(21) Appl. No.: 14/409,775

(22) PCT Filed: Jun. 11, 2013
(86) PCT No.: PCT/FR2013/051344

§ 371 Date: Dec. 19, 2014

(30) Foreign Application Priority Data
Jun. 21, 2012 (FR) 1255825

(51) Int. Cl. B60L 11/18; H02J 7/00

(52) U.S. Cl. CPC B60L 11/182; H02J 7/007

(57) ABSTRACT

A method for controlling charging of a battery of an electric drive motor vehicle or a hybrid motor vehicle, in a non-contact charging system wherein a power generator including a direct current source followed by an inverter feeds a load including an inductor arranged in series with the inverter, the method including: controlling the inverter at a working frequency slaved to a load resonance frequency by transmission of first and second pulse-width modulation command signals respectively to first and second switching arms of the inverter; and performing a closed-loop regulation on an intensity of a supply current of the inverter, a supply current set value being defined according to a maximum current that can be supplied by the direct current source.

The invention relates to a method for controlling the charging of a battery of an electric or hybrid drive motor vehicle in a non-contact charging system, wherein a power generator of the type comprising a DC voltage source followed by an inverter feeds a load comprising an inductor, said load being connected in series with the output of said inverter, said method comprising a step of controlling said inverter at a working frequency slaved to a frequency close to the load resonance frequency at the output of said inverter by transmission of first and second pulsewidth modulation command signals to first and second switching arms respectively of said inverter.

The systems for charging a motor vehicle battery referred to as “non-contact” systems are well known and conventionally comprise on the one hand, arranged for example on the floor of a parking space of a vehicle, an energy emitter terminal comprising an inductor fed by an inverter power generator connected to the mains and on the other hand, arranged in the vehicle, an energy receiver terminal designed to be placed above the inductor so as to allow a transfer of energy by inductive coupling between the inductor and the receiver terminal and so as to thus allow the recharging of the battery of the vehicle.

The benefit of these systems lies in the comfort and ergonomics of use compared with conventional wired recharging systems. However, these non-contact charging systems have the disadvantage of requiring very accurate positioning of the vehicle relative to the energy emitter terminal so as to avoid a drop of the efficiency of the charging phase of the battery. It has also been envisaged in document FR2947113, in the name of the applicant, to provide a solution consisting of controlling the inverter bridge of the power generator at a frequency substantially equal to the value of the resonance frequency of the load constituted by the inductor and the receiver terminal, irrespective of the positioning of the vehicle with respect to the energy emitter terminal. The resonance increases the efficiency by concentrating the magnetic field over the receiver terminal. Optimal efficiency and maximum tolerance of the positioning are thus obtained.

However, further disadvantages remain. In particular, the high-voltage batteries used to power the motors of electric drive vehicles have a low impedance. Also, in this application, when the resonance frequency is nearly reached and it is sought to recharge the battery, the impedance seen by the power generator becomes very low and consequently the currents drawn from the continuous power supply of the inverter become very high with no possibility for controlling said currents. The power supply then risks passing almost instantaneously into a state of current saturation, which is manifested conventionally by a switchover into “default” mode of the power supply.

In addition, it is also desirable to be able to control the power injected into the battery at medium and low levels, in particular toward the end of the recharging cycle of the battery, moreover whatever the relative positioning between the emitter terminal and the vehicle.

In this context, the object of the present invention is to propose a method for controlling the charging of a battery of an electric or hybrid vehicle, said method being capable of controlling the injected power in a precise manner while taking into account the actual limitations of the available power supplies.

With this object, the method of the invention, in accordance with the generic definition provided in the introduction above, is basically characterized in that a closed-loop regulation is performed on the intensity of the supply current of said inverter, a supply current intensity set value being defined according to the maximum current that can be supplied by said DC voltage source of said inverter.

The method according to the invention preferably also has one or more of the following features:
the current passing through the load is measured at the output of said inverter, the measured current is compared with said current set value, and the pulsewidth modulation command signals of said inverter are adapted if the measured current differs from the set value, such that the current passing through the load at the output of said inverter is substantially equal to the set value;
the closed-loop regulation of the intensity of the supply current is implemented by adapting the duty cycle of the first and second command signals of said inverter;
the second command signal of said inverter is a signal complementary to that of the first command signal of said inverter;
the closed-loop regulation of the intensity of the supply current is implemented by varying the phase between the first and second command signals of said inverter;
a closed-loop regulation of the power transmitted by said inverter is implemented simultaneously by acting on the control of the supply voltage of said inverter, a power set value being established according to a piece of electrical power information required for the charging of the battery;
the piece of electrical power information required for the charging of the battery is transmitted by a battery supervision computer according to a battery charging completion strategy;
the enslavement of the working frequency of said inverter to a frequency close to the resonance frequency of said load at the output of said inverter lies in performing a closed-loop regulation of the phase difference between the ripple supply voltage and the ripple supply current delivered at the output of said inverter, a phase difference set value being determined in such a way that the working frequency of said inverter is kept constant at a value substantially equal to that of the load resonance frequency at the output.

The invention also relates to a computer comprising hardware and/or software means for carrying out the method according to the invention.

Further features and advantages of the invention will become clear from the exemplary description hereinafter, which is in no way limiting, with reference to the accompanying drawings, in which:

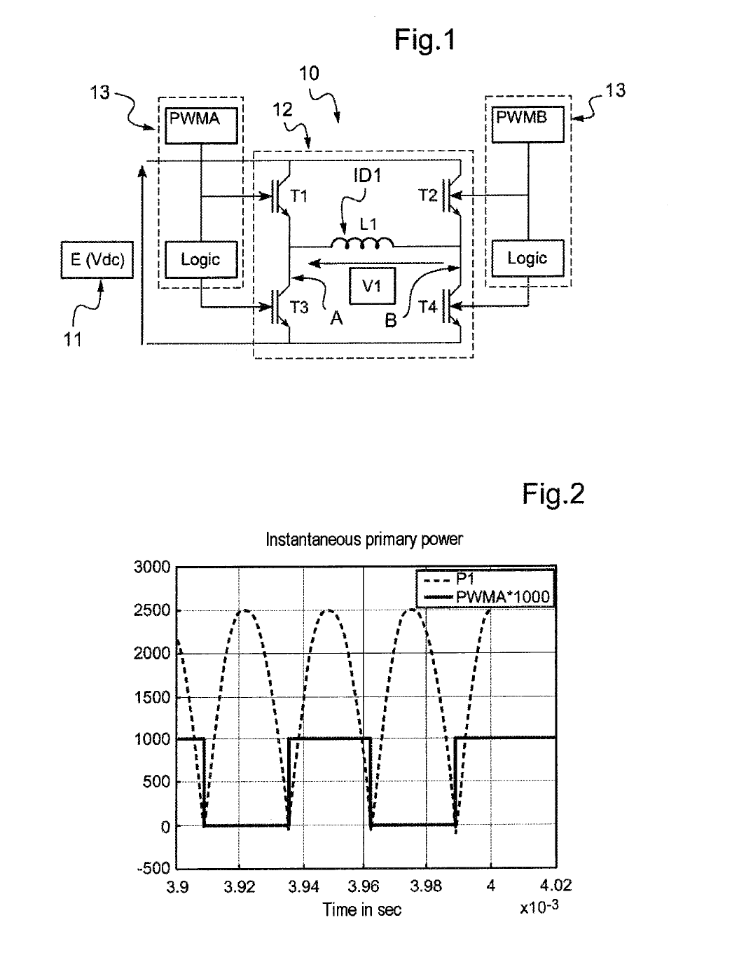

FIG. 1 is a schematic view of an inverter power generator implemented in a non-contact charging system for an electric or hybrid vehicle battery;

FIG. 2 is a graph illustrating the rate of the power injected at the load for a duty cycle of 0.5 of the PWM control of the commutators of the inverter when said inverter is at resonance;

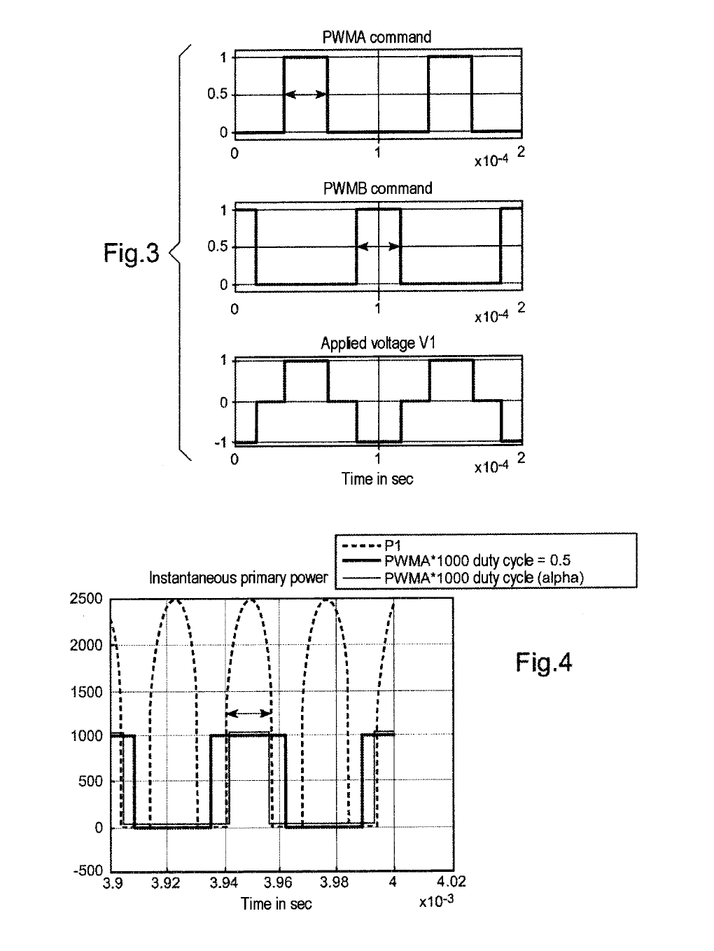

FIG. 3 is a graph illustrating the waveforms of the first and second command signals transmitted to the two switching arms of the inverter respectively, with a duty cycle equal to 0.3 in accordance with the shown example, and of the resultant voltage applied at the output of the inverter;

FIG. 4 is a graph illustrating the rate of the power injected for a duty cycle of 0.3 of the PWM control of the commutators of the inverter;

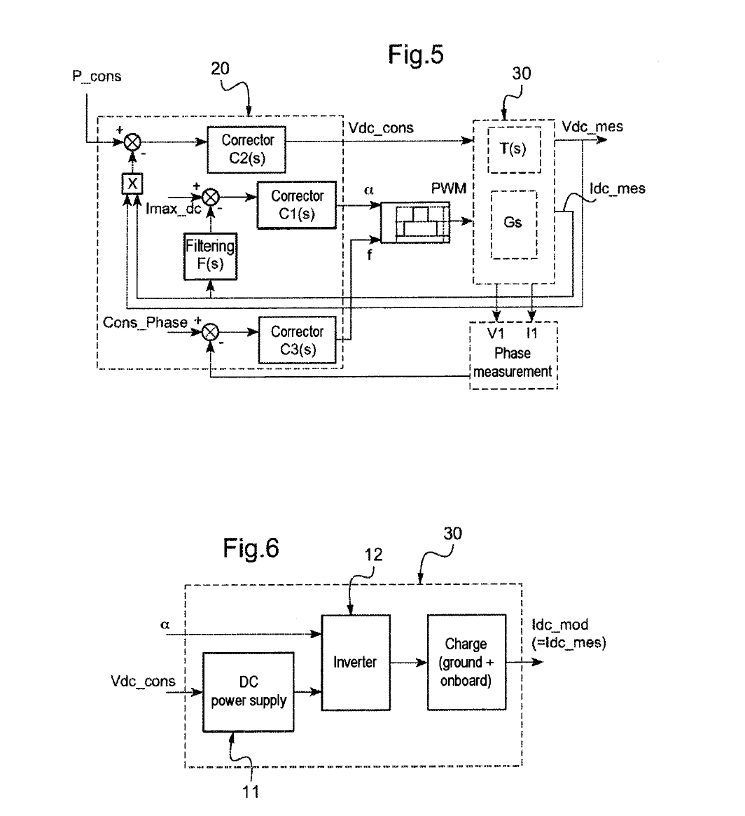

FIG. 5 is a circuit diagram of a charging control device for carrying out the method according to the invention; and

FIG. 6 is a diagram illustrating the system to be regulated to which the method according to the invention is applied.

FIG. 1 shows the conventional diagram of an inverter power generator 10 with pulsewidth modulation PWM control, used to supply a load arranged in series with the output. The power generator 10 comprises a DC voltage source 11, which for example is formed by rectifying a 230 V mains AC voltage and which provides a regulated and regulatable DC supply voltage E of amplitude Vdc to an inverter 12. This inverter 12 has a bridge structure with four switches T1 to T4, such as IGBT power transistors (insulated gate bipolar transistors), the transistors T1-T3 and T2-T4 that form the two switching arms A and B of the inverter 12 being connected in series between the two positive and negative terminals of the DC voltage source 11.

The load for the power generator 10 in particular comprises an inductor denoted ID1, which can be regarded as an inductor L1 arranged in series with a capacitor (not shown), thus forming a resonant circuit.

The inductor ID1 is connected at the output of the inverter 12 between the two switching arms A and B of the inverter 12, such that each of the terminals of the inductor ID1 is connected to the two positive and negative supply terminals of the DC voltage source 11 by two transistors respectively. In order to regulate the power absorbed by the resonant circuit at the output of the inverter 12, it is possible to act on the frequency of successive cycles of conduction and non-conduction of the transistors, by means of a control circuit 13 able to generate command signals of the PWM type to send to the transistors, basically making it possible to control the frequency, referred to as the working frequency of the inverter, at which the transistors conduct and block.

Thus, by controlling the passing-blocking state of the transistors by an appropriate PWM control emitted by means of the control circuit 13, it is possible to fix the voltages at the terminals of the inducer ID1 so as to obtain an AC voltage V1. The AC voltage V1 delivered by the inverter 12 to the inductor ID1 makes it possible to generate a magnetic field, used to induce a current in a secondary winding (not shown) of the receiver terminal installed in the vehicle, said secondary winding being connected to a rectifying and filtering circuit, in order to charge the battery. The charging current absorbed by the inductor results from the voltage applied to said inductor. This current and the control of the transistors fix the supply current Idc of the inverter 12, that is to say the current drawn from the DC voltage source 11 of the inverter 12.

The inverter 12 can be controlled by command signals having a PWM duty cycle profile equal to 0.5, and the control electrodes of two transistors in series are controlled in opposition. In particular, a command signal PWMA controls the opening and the closing of the transistor T1, whereas a control logic is designed to construct the command signal of the transistor T3 by inverting the signal PWMA and by ensuring a dead time in order to avoid the short circuit of the power source of the inverter. Similarly, with regard to the second branch of the inverter 12, a command signal PWMB, which is the complement of the signal PWMA, controls the opening and the closing of the transistor T2, whereas a control logic is designed to construct the command signal of the transistor T4.

The power transmitted to the load by the inverter 12 is dependent in particular on the amplitude Vdc of the DC supply voltage E of the inverter 12, on the ripple supply voltage V1 applied to the inductor ID1, and on the intensity I1 of the current running through the inductor ID1 at the output of the inverter 12. For a given amplitude Vdc of the supply voltage E, the power transmitted is maximal when the switching frequency is equal to the load resonance frequency. FIG. 2 illustrates the waveforms of the PWM control of the inverter for a duty cycle of 0.5 and of the transmitted power P1 when the inverter is at resonance.

The transmitted power corresponds to a full wave rectified sine, and the current passing through the load has exactly the same rate as the power.

The average values are then calculated in the following manner:

$${P}_{av} = \frac{2}{π} {P}_{peak} , respectively {I}_{av} = \frac{2}{π} {I}_{peak} ,$$

Pₐᵥ corresponding to the power thus transferred,

Pₚₑₐₖ corresponding to the maximum value (peak value) of the power,

Iₚₑₐₖ corresponding to the maximum value of the current (peak value) Iₐᵥ referring to the average value of the supply current Idc at the output of the DC voltage source 11 of the inverter 12.

In accordance with the invention, the inverter 12 is controlled with PWM command signals which are no longer complemented, but have a different duty cycle 0.5, in order to influence the ratio between the periods of conduction and of non-conduction of the transistors over a working period so as to inject the electrical power only during a fraction of the period.

FIG. 3 illustrates the waveforms of the first and second command signals PWMA and PWMB transmitted to the two switching arms respectively of the inverter, which have a duty cycle lower than 0.5 (equal to 0.3 in the shown example), and of the voltage V1 applied at the output of the inverter as a result of this. FIG. 4 then illustrates the waveforms of the command signal PWMA for a duty cycle of 0.3, superposed with the same command signal for a duty cycle of 0.5, and of the power transmitted to the load for this duty cycle of 0.3.

Also, for a given amplitude Vdc of the supply voltage E of the inverter 12, if this is controlled with the aid of PWM command signals, the duty cycle thereof is:

Rc=0.5.α, with 0<α<1.

Thus, the average power transmitted to the load, or respectively the current drawn from the DC voltage source of the inverter, i.e. the average current running through the load at the output of the inverter, is this time:

$${P}_{av} = \frac{2}{π} sin ( α \frac{π}{2} ) \cdot {P}_{peak} , respectively {I}_{av} = \frac{2}{π} sin ( α \frac{π}{2} ) \cdot {I}_{peak}$$

An average current referred to as a controlled current is thus obtained. The application of a duty cycle lower than 0.5 is thus equivalent to the implementation of a virtual transformer, which would reduce the amplitude Vdc actually applied of the supply voltage of the inverter and therefore would increase the supply current Idc due to the conservation of the power. It is thus possible, by acting on the duty cycle of the PWM command signals of the inverter, to exceed the limitation of DC supply current of the inverter, and the duty cycle thus provides an additional variable for the control of the system in addition to the amplitude Vdc of the supply voltage E of the inverter.

FIG. 5 illustrates a circuit diagram of a charging control device making it possible to carry out the method according to the invention. This device is implemented in the form of a computer 20 present at the emitter terminal on the ground, having hardware and/or software means in order to carry out the method of the invention. The system 30 to be regulated, illustrated in FIG. 6, is formed by the power generator 10, comprising a DC power supply (voltage source 11) followed by the inverter 12, and by the load arranged in series with the output of the inverter 12 for a part on the ground, formed by the inductor ID1 and for another part onboard a vehicle, formed by the receiver terminal.

Thus, in accordance with the principles detailed above, the charging control device comprises a first loop, in accordance with a closed-loop structure, for regulating the intensity of the supply current Idc of the inverter 12. This regulation is preferably performed by acting on the duty cycle of the command signals PWMA and PWMB of the inverter 12. To this end, the DC supply of the inverter 12 is able to transmit to the computer 20 a measured value Idc_mes of the intensity of the supply current, corresponding to the average value Idc_mod of the ripple current passing through the load at the output of the inverter, that is to say Idc_mod=Idc_mes. A current set value Imax_dc is calculated in the computer 20 on the basis of the maximum current value able to be provided by the DC voltage source 11. The loop for regulating the supply current Idc thus makes it possible to limit this current to the maximum value that can be drawn from the DC voltage source. This regulation can be implemented for example thanks to a corrector C1(s). In order to regulate the regulation, it is necessary to know the transfer function G(s) between the parameter a making it possible to modulate the duty cycle Rc of the command signals PWMA and PWMB of the inverter to a value different from 0.5 and the current Idc mes. In other words, this is M, which is the gain modulation brought about by a duty cycle different from 0.5. M is obtained by calculating the average value of the current at the output of the inverter when said current has the rate shown by the waveform illustrated in FIG. 2.

$$M = sin ( α \frac{π}{2} ) and Rc - 0.5 α , with 0 < α < 1.$$

The dynamic between a and the current measurement Idc_mes is ignored. The dynamic part of the transfer is imposed by adding a low-pass filter F(s) to the current measurement Idc_mes, as follows:

$$F ( s ) = \frac{1}{1 + \frac{s}{{ω}_{c\_BO}}} ,$$

with ω_{c}_{_{—}}_{BO} the cut-off pulse in rad/s and s the Laplace variable.

Thus, a corrector of the PI type is selected, as follows:

$$C 1 ( s ) = {K}_{p} + \frac{{K}_{i}}{s}$$

Kₚ being the proportional gain and Kᵢ being the integral gain.

These gains are easily regulated since the system to be controlled has a known gain (defined by M) and a known dynamic (defined by F(s)). The methods for calculating Kₚ and Kᵢ on the basis of M and of F(s) are thus well known by a person skilled in the art, since an analytical calculation is possible. Thus, thanks to this first regulation loop, the current Idc is fixed so as to be constant, equal to the maximum current that can be generated by the DC power supply of the inverter. In this application, the term “equal” means “substantially equal”, the evaluation of the maximum current that can be generated by the power supply of the inverter varying in accordance with the method for estimating this value.

In a variant, the intensity of the supply current is regulated by adapting the duty cycle of the command signals PWMA and PWMB of the inverter, as explained above, but the command signal PWMB is a signal complementary to that of the first command signal PWMA.

In a further variant, the inverter bridge 12 is controlled by two command signals PWMA and PWMB of duty cycles equal to 0.5, but the phase between the command signals PWMA and PWMB of the inverter 12 is varied, such that the supply current of the inverter is slaved to the set value Imax_dc.

In addition, the computer on the ground 20 is able to receive from the battery supervision computer a power charging request comprising a charging power set value P_cons corresponding to the required power. Since the first loop for regulating the current drawn from the DC supply of the inverter mentioned above receives directly at the input the value Imax_dc of the maximum current able to be provided by the DC voltage source, it is possible to calculate a supply voltage level set value Vdc_cons to be applied to the inverter, on the basis of the power required to charge the battery, as follows:

$$Vdc\_cons = \frac{P\_cons}{Imax\_dc}$$

This mode of control makes it possible to respond efficiently to elevated required powers, since it makes it possible to reach the maximum power able to be generated by the DC voltage source (Pmax_dc=Vdc_max x Imax_dc). By contrast, it is unreliable in practice, since it requires the loop for regulating the supply current Idc of the inverter to function permanently without saturation. In particular at low power values, the current Imax dc cannot be reached. Consequently, such a power regulation mode is not suitable for implementing a precise control of the power transmitted by the inverter, in particular at the low power values likely to be required in the strategies for controlling the completion of battery charging.

Also, the charging control device further comprises a second closed-loop regulation loop for regulating the level of power actually injected by the inverter, acting simultaneously with the first loop for regulating the supply current Idc. The power set value P_cons comes from the battery supervision computer, and this set value is determined for example according to the power level required within the scope of the application of a strategy for battery charging completion. This set value is then compared to the power actually transmitted by the inverter, which is calculated on the basis of the values returned to the computer 20 by the DC supply of the inverter concerning the measured supply voltage Vdc_mes and the measured supply current Idc_mes.

For example, the regulation can be implemented thanks to a corrector C2(s), making it possible to ensure the precise regulation of the transmitted power. In order to regulate the regulation, a second corrector C2(s) of the PI type is synthesized, and this synthesis is based on the knowledge of the transfer function T(s) between the measurement of the supply voltage of the inverter Vdc_mes and the control thereof Vdc_{—cons.}

Also, the first corrector C1(s) makes it possible to ensure the control of the supply current of the inverter to the maximum value able to be provided by the DC voltage source of the inverter power generator, whereas the second corrector C2(s) makes it possible to ensure a precise regulation of the power injected by the inverter power generator.

Lastly, the charging control device comprises a third regulation loop in accordance with a closed-loop structure, acting simultaneously with the two regulation loops described above and aimed at regulating the working frequency f of the inverter so as to enslave the frequency of the ripple supply voltage V1 delivered by the inverter 12 to a frequency close to the load resonance frequency at the output of the inverter. To this end, a third corrector C3(s) of the PI type is synthesized, and the phase difference between the ripple supply voltage V1 and the ripple supply current I1 at the output of the inverter 12 according to a phase difference set value Cons_Phase determined by the computer 20 is selected as a regulation parameter of this third regulation loop.

Also, the control method of the invention makes it possible to perform simultaneously 3 regulation functions by means of 3 correctors, which make it possible respectively to control the supply current, to inject exactly the power desired, including at medium and low levels, and to remain at the resonance of the system.

1-9. (canceled)

10. A method for controlling charging of a battery of an electric or hybrid drive motor vehicle in a non-contact charging system, wherein a power generator including a DC voltage source followed by an inverter feeds a load including an inductor, the load being connected in series with an output of the inverter, the method comprising:
controlling the inverter at a working frequency slaved to a frequency close to a load resonance frequency at the output of the inverter by transmission of a first pulsewidth modulation command signal and a second pulsewidth modulation command signal to a first switching arm and a second switching arm respectively of the inverter;
performing a closed-loop regulation of an intensity of a supply current of the inverter, a supply current intensity set value being fixed to be constant, equal to a maximum current able to be provided by the DC voltage source of the inverter; and
performing a closed-loop regulation of power transmitted by the inverter simultaneously by acting on a control of a supply voltage of the inverter, a power set value being established according to a piece of electrical power information required for the charging of the battery.

11. The method as claimed in claim 10, wherein the supply current passing through the load at the output of the inverter is measured, the supply current measured is compared to the current set value, and the pulsewidth modulation command signals of the inverter are adapted if the measured current differs from the set value, such that the current passing through the load at the output of the inverter is substantially equal to the set value.

12. The method as claimed in claim 10, wherein the closed-loop regulation of the intensity of the supply current is performed by adapting a duty cycle of the first command signal and second command signal of the inverter.

13. The method as claimed in claim 12, wherein the second command signal of the inverter is a signal complementary to that of the first command signal of the inverter.

14. The method as claimed in claim 10, wherein the closed-loop regulation of the intensity of the supply current is performed by varying a phase between the first command signal and the second command signal of the inverter.

15. The method as claimed in claim 10, wherein the power set value is compared to power actually transmitted by the inverter, the power actually transmitted being calculated based on measured values of the supply voltage and of the supply current.

16. The method as claimed in claim 10, wherein the piece of electrical power information required for the charging of the battery is transmitted by a battery supervision computer according to a battery charging completion strategy.

17. The method as claimed in claim 10, wherein enslavement of the working frequency of the inverter to a frequency close to the resonance frequency of the load at the output of the inverter includes performing a closed-loop regulation of a phase difference between a ripple supply voltage and a ripple supply current delivered at the output of the inverter, a phase difference set value being determined such that a working frequency of the inverter is fixed to be constant at a value substantially equal to that of the resonance frequency of the load at the output.

18. A computer, comprising hardware and/or software means for carrying out the method as claimed in claim 10.
